(19) United States
(12) Patent Application Publication
(10) Pub. No.: US 2010/0201507 A1
(43) Pub. Date: Aug. 12, 2010

(54) DUAL-MODE VISION SYSTEM FOR VEHICLE SAFETY

(75) Inventors: Manoharprasad K. Rao, Novi, MI (US); Tai Luu, Westland, MI (US); Mark A. Cuddihy, New Boston, MI (US)

Correspondence Address: BROOKS KUSHMAN P.C./FGTL, 1000 TOWN CENTER, 22ND FLOOR, SOUTHFIELD, MI, 48075-1238, US

(73) Assignee: Ford Global Technologies, LLC, Dearborn, MI (US)

(21) Appl. No.: 12/370,130

(22) Filed: Feb. 12, 2009

(51) Int. Cl. B60Q 1/00; H04N 7/18

(52) U.S. Cl. 340/435; 348/148

(57) ABSTRACT

A dual-mode imaging system for a vehicle includes an electro-optical camera mounted inside the passenger cabin and a drive unit for rotating the camera between a rear view position wherein the camera images an area rearward of the vehicle and a seating view position wherein the camera images a seating area within the cabin. When the vehicle is in a non-reverse travel mode, an electronic control module (ECM) directs the camera to the seating view position and analyzes imagery to determine an occupancy status for at least one seating position. A safety system undergoes a function change based on the occupancy status. When the powertrain is in a reverse travel mode, the ECM directs the camera to the rear view position and imagery from the camera is presented on a display screen displays for viewing by the vehicle operator while backing up.

### BACKGROUND

1. Field

The present invention relates generally to vision systems for passenger vehicles and specifically to a vision system providing both occupant safety and backup safety benefits.

2. Background Art

In the field of passenger vehicle safety, it has been proposed to use a so-called “artificial vision” system to detect the presence, position, and classification (size, for example) of a vehicle occupant within the passenger cabin of the vehicle. Such artificial vision systems usually use an electro-optical sensor such as a CCD (charge-coupled device) or CMOS (complimentary metal-oxide semiconductor) image sensor, the digital output of which is passed to a digital signal processor or other computational device for scene analysis. Vehicle safety systems such as airbags, seat belt pre-tensioners, and deployable bolsters may be activated or deactivated as appropriate, depending upon the presence, position, and/or classification of occupants in the various seating positions within the passenger cabin. U.S. Patent Application 2006/0056657A1, for example, discloses a system in which an imaging sensor is mounted on or near an A-pillar of the vehicle and equipped with a wide-angle lens in order to capture a field of view that includes almost the entire passenger compartment. The reference also suggests that proper orientation of the imaging sensor may also allow the sensor to be used to monitor a rear-view mirror blind spot.

It is also known to use a rear-view camera system to image the environment behind a vehicle. Such systems typically display the image of the rear area on a video screen to be viewed by the vehicle operator during reverse motion of the vehicle. It has been proposed to use artificial vision to analyze the scene behind the vehicle, identify objects of which the vehicle operator should be aware when backing-up (pedestrians, bicyclists, other vehicles, fixed obstructions, etc.), and alert the vehicle operator to any such objects so that they may be safely avoided.

German patent publication DE10342972 discloses a vehicle having a panoramic-view camera that is movable along a mounting bar between a first position outside of the body of the vehicle where it monitors the exterior of the vehicle and a second position inside of the body where it monitors the interior of the vehicle. The camera may be moved to the first, exterior position when the vehicle is in a reverse gear.

### SUMMARY

In a disclosed embodiment of the invention, a dual-mode imaging system for a vehicle features an electro-optical imaging device mounted inside of the vehicle passenger cabin. The mount for the imaging device includes a drive unit for rotating the imaging device between a rear view position and a seating area view position. In the rear view position, the imaging device is oriented to aim through a rear window of the vehicle in order to image a back-up area rearward of the vehicle, while in the seating view position the imaging device is oriented to aim at and image a seating area within the passenger cabin. At least one electronic control module (ECM) receives information indicating the travel direction mode of a vehicle powertrain.

When the powertrain is in a non-reverse travel (forward or parking/stationary) mode, the ECM operates in an occupant safety mode, directing movement of the imaging device to the seating view position and determining an occupancy status for at least one seating position in the seating area based upon imagery received from the imaging device. A safety system undergoes a function change based on the occupancy status. For example, an airbag associated with a seating position that is determined to be unoccupied may be disabled.

When the powertrain is in a reverse travel mode, the ECM operates in a backup mode, directing movement of the imaging device to the rear view position. A display screen displays images from the imaging device for viewing by the vehicle operator while backing up.

In a further embodiment of the invention, the at least one ECM is further operative in the backup mode to analyze imagery from the imaging device and identify objects that may obstruct reverse travel of the vehicle and/or be safety hazards. Upon detection of such an object the vehicle operator may be alerted, and/or an automatic intervention in the vehicle powertrain and/or braking system may be triggered to slow or stop rearward motion of the vehicle if necessary to avoid striking the object.

In a further embodiment of the invention, the at least one ECM is further operative in the occupant safety mode to direct a function change in at least one occupant comfort system based on the occupancy status. For example, a vehicle climate control may reduce air flow to unoccupied portions of the vehicle cabin.

### BRIEF DESCRIPTION OF THE DRAWINGS

The features of the present invention are set forth with particularity in the appended claims. The present invention, both to its organization and manner of operation, together with further objectives and advantages thereof, may be best understood with reference to the following description, taken in connection with the accompanying drawings in which:

FIG. 1 is an overall schematic view of a passenger vehicle having a dual-mode vision system;

FIG. 2 is a side view of camera and rotating mount of a dual-mode vision system;

FIG. 3 is a front view of a camera and rotating mount;

FIG. 4 is a schematic illustration of a first embodiment of a dual-mode vision system; and

FIG. 5 is a schematic illustration of a second embodiment of a dual-mode vision system.

### DETAILED DESCRIPTION OF EMBODIMENT(S)

By way of example, a system and method for implementing the present invention is described below. The system and methodology may be adapted, modified or rearranged to best fit a particular implementation without departing from the scope of the present invention.

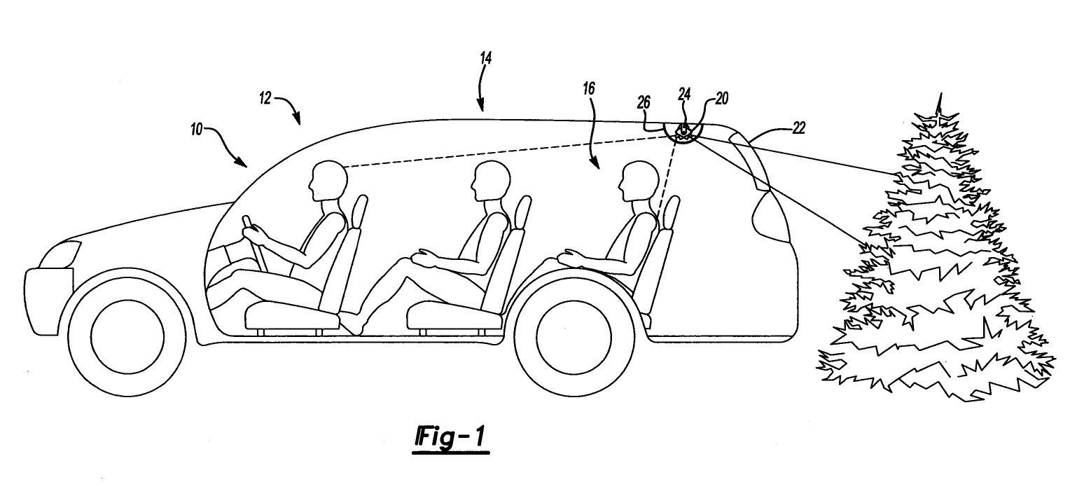

Referring to FIG. 1, a vehicle 10 includes a passenger compartment comprising a front seating row 12, a second seating row 14, and a rear seating row 16. Rear seating row 16 may comprise a bench-type seat with two or more seating positions or multiple individual seats. It is also possible to practice the present invention to vehicles having more than or fewer than three seating rows.

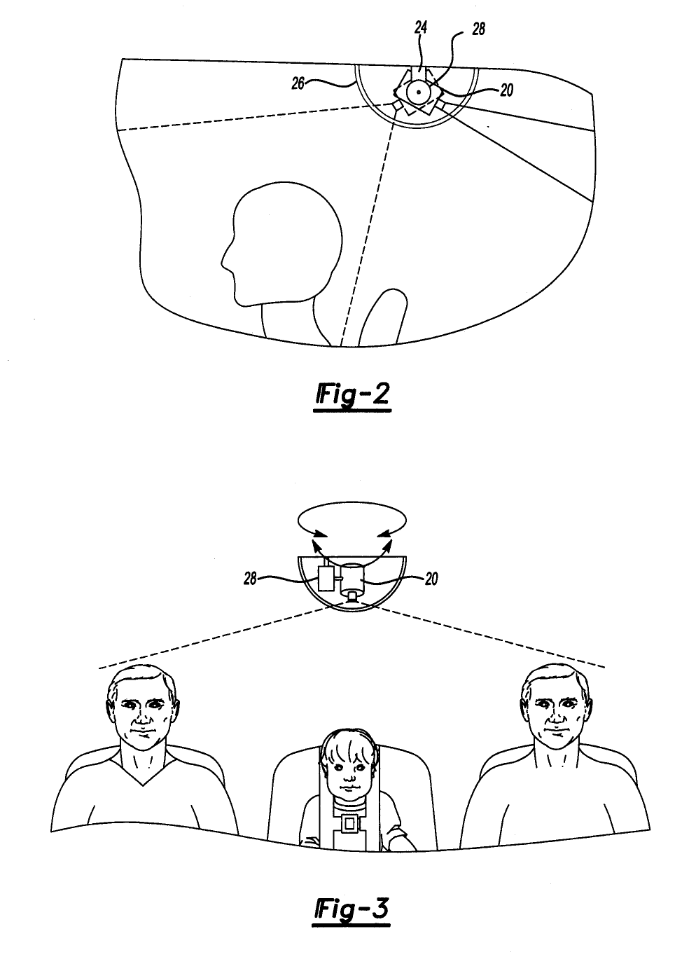

An electro-optical imaging device, hereafter referred to as a camera 20, is located adjacent the upper rear portion of the passenger compartment near to where a rear window 22 meets the interior of vehicle roof. As best seen in FIG. 2, camera 20 is held by a rotating mount 24 and the camera 20 and mount are preferably enclosed by a housing 26. Housing 26 may be integrated with the headliner forming the inner surface of the roof, or the housing 26 may be a separate component. Camera 20 may operate in the visible, near-infrared, or any appropriate spectrum and preferably employs a CCD (charge-coupled device) or CMOS (complimentary metal-oxide semiconductor) image sensor. Housing 26 may be entirely transparent to the spectrum utilized by camera 20, or the housing may have transparent panels located at positions through which the camera points.

Rotating mount 24 includes a drive unit 28 operable to rotate camera 20 about an axis oriented generally parallel with the lateral axis of the vehicle. Drive unit 28 may be electrically powered and may, for example, be a stepper motor. Rotating mount 24 permits camera 20 to rotate between an interior view position (indicated by the dashed lines in FIGS. 1 and 2) wherein the camera 20 is oriented to image rear seating rows 14 and 16 and a rear view position (indicated by the solid lines in FIGS. 1 and 2) wherein the camera 20 is oriented to point through the rear window 22 and image the environment behind the vehicle.

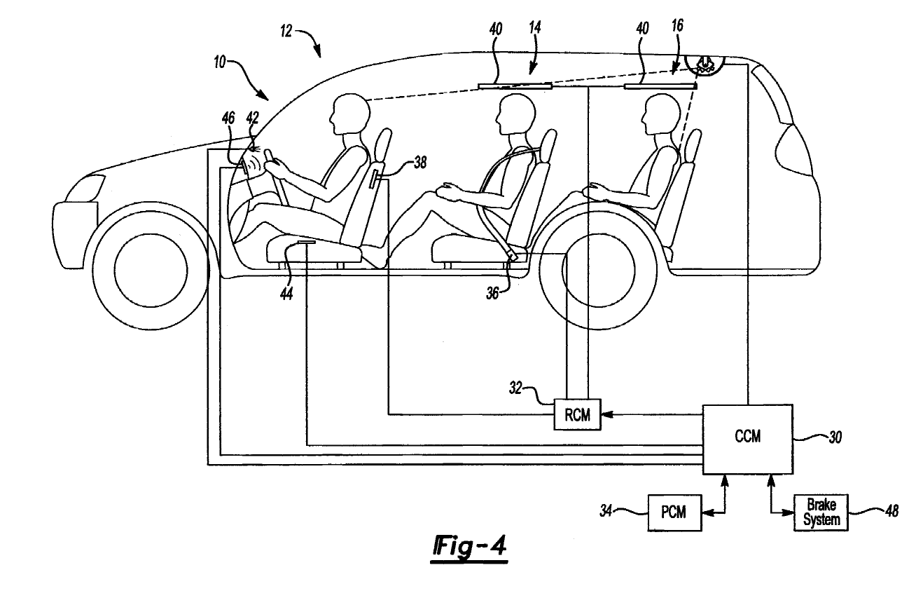

Referring now to FIG. 4, a camera control module (CCM) 30 is electronically interfaced with camera 20 and rotating mount 24 to control movement and other functionality of the camera 20. CCM 30 is an electronic control module, preferably employing micro-processors, using artificial vision software to processes the digital imagery received from camera 20 and perform object detection, recognition, and/or classification. CCM 30 is in electronic communication with other vehicle systems such as a restraints control module (RCM) 32 and a powertrain control module (PCM) 34.

RCM 32 is an electronic control module interfaced with and controlling operation of one or more occupant safety systems associated with one or more seating positions in the passenger compartment. Examples of such occupant safety systems are seatbelt pre-tensioners 36, rear seat airbags 38, and side curtain airbags 40. While FIG. 4 deals primarily with the second seating row, RCM 32 may control safety systems associated with any seating position in any of the seating rows. RCM 32 receives signals from one or more crash sensors or pre-crash sensors (not shown) and controls actuation of the occupant safety systems as required to maximize occupant safety in the event of a crash.

PCM 34 is an electronic control module that controls and/or monitors all or parts of the functions of the vehicle's powertrain (not shown). The present invention is applicable to any type of vehicle powertrain, including those using a conventional internal combustion engine, a hybrid electric system, a pure electric system, and a fuel cell electric system.

CCM 30 receives information from PCM 34 indicating whether the vehicle powertrain is in a reverse travel mode, a forward travel mode, or a parking/stationary mode. For convenience of terminology, the forward travel mode and parking/stationary mode will hereafter be referred to together as constituting a non-reverse travel mode. When the PCM 34 indicates the vehicle powertrain is in a non-reverse mode, CCM 30 enters an occupant safety mode in which CCM 30 actuates drive unit 28 to rotate camera 20 to the interior view position. In the interior view position, camera 20 is oriented to image one or more seating positions within the passenger compartment. In the occupant safety mode, CCM 30 receives digital images of the seating positions and applies artificial vision software to identify whether each of the seating positions is occupied or unoccupied. CCM 30 may also determine the position of an occupant with respect to the seating position, and/or may also determine a classification of an occupant.

The occupied/unoccupied determination made by CCM 30 is communicated to RCM 32 and used by RCM 32 as an input in making decisions as to the operating mode or status of one or more occupant safety systems. RCM 32 will typically receive inputs from many other vehicle systems (not shown) and apply pre-programmed logic to make the operating mode and/of status decisions. For example, RCM 32 may deactivate a rear seat airbag 38, a side curtain airbag 40, and/or other safety device for any seating position that is unoccupied. RCM 32 may also be connected with and control safety systems related to the front and/or rear row seating positions, but such connections and systems are not shown for clarity.

If a seating position is occupied, the determination of the position of the occupant relative to the seating position and/or to the safety devices may be used by RCM 32 in deciding whether/how to activate a safety device. For example, if an occupant is determined to be out-of-position with respect to a safe operating zone for an airbag, RCM 32 may suppress activation of the airbag. Similarly, the determination of the classification of the occupant present may be used by RCM 32 in deciding whether and in what mode to activate a safety device. For example, the size of an occupant may be used by RCM 32 as one factor in determining the optimum activation force for an airbag.

It is also possible to alert the vehicle operator to an out-of-position occupant condition detected by CCM 30 and/or RCM 32. Such an alert may be provided by an audible signal from a speaker 42, a haptic signal from a vibrator 44, or a visual signal displayed on a video display 46 or other appropriate display. It is further possible to alert vehicle operator in the case that an occupied seating position does not have its related seat belts properly fastened or other safety systems improperly employed. It is further possible to display the image of the seating area on the video display 46 for viewing by vehicle operator.

As shown in FIG. 3, camera 20 may be adapted to image the full width of a rear row of seats and to identify distinct seating positions within that row. In general, each of the seating positions will coincide with the provision of a seat belt or other occupant restraint system. In the example of FIG. 3, there are three seating positions: left, center and right. Camera 20 may be provided with a wide-angle lens that allows it to image all three of the seating positions simultaneously. In such an embodiment of the invention, the digital image captured by camera 20 may be divided into zones that identify and coincide with the seating positions. The artificial vision software and/or system of CCM 30 may then analyze each of the image zones independently to distinguish between and determine an occupancy status for each of the seating positions.

It is also possible for the mounting and drive unit to be adapted to allow the camera 20 to physically scan left and right, and/or to rotate (as indicated by the curved arrows in FIG. 3) as necessary to image all of the seating positions in the row sequentially.

When PCM 34 indicates that the vehicle powertrain is in a reverse travel mode, CCM 30 enters a backup mode. In the backup mode, CCM 30 actuates drive unit 28 to rotate camera 20 to the rear view position as illustrated in FIG. 1. In the rear view position, camera 20 is oriented such that its lens points through the rear window to image the environment behind the vehicle. Camera 20 may, depending upon its positioning and the field-of-view of the lens, also image the environment somewhat to the left and right sides of the vehicle. The environment imaged by camera 20 when in the backup mode is hereafter referred to as the backup area.

In the backup mode, CCM 30 receives digital images of the backup area from imaging device and applies artificial vision software to detect and/or identify objects that may obstruct reverse travel of the vehicle and/or be safety hazards. If the vehicle is equipped with other rearward-looking sensors, such as an ultrasonic, RF radar, or laser radar (LIDAR) system, information from those sensors may be used in combination with (fused with) the video image information to detect and/or classify objects.

When an object in the backup area is identified by CCM 30 as being an obstacle, a hazard, or otherwise of possible interest to the vehicle operator, a visible and/or audible and/or haptic alert is provided to the driver using video display screen 46, audible alerting device 42, and haptic alerting device 44 respectively. An automatic intervention in the vehicle powertrain and/or braking system 48 may also be triggered to slow or stop rearward motion of the vehicle if necessary to avoid striking the object. It is further possible to display the image of the backup area on the video display 46 for viewing by the vehicle operator.

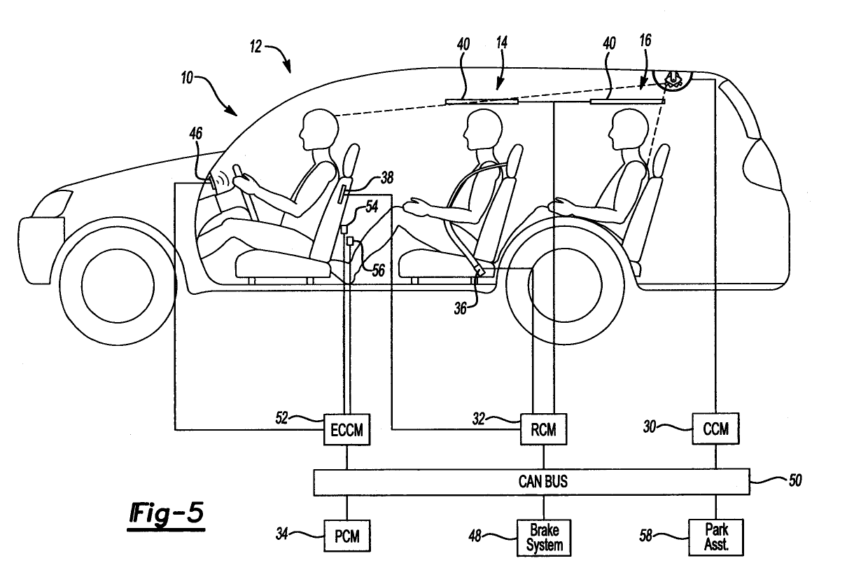

FIG. 5 schematically illustrates a second embodiment of a dual-mode vision system. Components of this embodiment that serve essentially the same or similar function as the components described in relation to FIG. 4 are numbered identically to those of FIG. 4. In this embodiment, a controller-area network (CAN) bus 50 is used to enable communications between various electronic components of the vehicle, as is well known in the automotive electronics field. CCM 30 receives information from one or more vehicle systems via CAN bus 50 and, based upon the information, enters either the occupant safety operating mode or the backup mode. In the occupant safety operating mode, the occupied/unoccupied determination made by CCM 30 may be communicated to any vehicle electronic systems interfaced with CAN bus 50, where it may be used as an input in directing a function change in the vehicle system(s). For example, Entertainment and Comfort Control Module (ECCM) 52 may receive the occupancy status determined by CCM 30 and use that information to control the settings of the vehicle HVAC system 54 so that the rear seat area is properly heated or cooled in accordance with the number and location of occupants. As another example, a rear seat audio or video entertainment system 56 may receive the occupancy status of the rear seat area and be adjusted as appropriate.

The object detection and/or object ranging capabilities of camera 20 and CCM 30 may also be utilized by a parking assist system 58. Such systems are well known in the art and typically utilize one or more sensors (optical, ultrasonic, RF radar, LIDAR, etc.) to determine whether a potential parking space is large enough to accepts the vehicle. Some parking assist systems then direct the vehicle operator and/or control the vehicle steering and/or the powertrain system as necessary to direct or move the vehicle into the parking space.

It will be understood by a person of skill in the art that the system architectures depicted in FIGS. 4 and 5 are for clarity of description and are not intended to limit the scope of the present invention, as many other system architectures are possible. For example, the functions performed by the separate control modules depicted may be combined or distributed into any number of electronic modules installed in the vehicle. Also, CCM 30 need not be a physically separate unit, but may be a function or process integrated with or residing on any other electronic control module(s) of the vehicle, such as RCM 32.

While the best mode for carrying out the invention has been described in detail, those familiar with the art to which this invention relates will recognize various alternative designs and embodiments for practicing the invention as defined by the following claims.

What is claimed:

1. A dual-mode imaging system for a vehicle having a passenger cabin, the system comprising:
an electro-optical imaging device;
a rotating mount for mounting the imaging device inside of the passenger cabin and comprising a drive unit for moving the imaging device between a rear view position wherein the imaging device is oriented to image a back-up area rearward of the vehicle through a window of the vehicle and a seating view position wherein the imaging device is oriented to image a seating area within the passenger cabin, the drive unit operable to move the imaging device to the rear view position when the vehicle is in a reverse travel mode and to the seating view position when vehicle powertrain is in a non-reverse travel mode;
at least one electronic control module operable when the vehicle is in a non-reverse travel mode to determine an occupancy status for at least one seating position in the seating area based upon imagery received from the imaging device, and further operable to direct a function change in at least one safety system based on the occupancy status; and
a video display screen displaying images from the imaging device when the imaging device is in the rear view position.

2. The system according to claim 1 wherein the at least one safety system comprises a driver alerting system and the function change comprises generating a driver alert.

3. The system according to claim 1 wherein the at least one safety system comprises an occupant restraint associated with the at least one seating position.

4. The system according to claim 3 wherein the function change comprises deactivating the occupant restraint when there is no occupant present in the at least one seating position.

5. The system according to claim 1 wherein the at least one electronic control module is further operative when the vehicle is in the reverse travel mode to analyze imagery of the backup area and identify a hazard object.

6. The system according to claim 5 wherein the at least one electronic control module is further operative to provide an alert to a vehicle operator when the hazard object is identified.

7. The system according to claim 5 wherein the at least one electronic control module is further operative to direct activation of an automatic braking system when the hazard object is identified.

8. The system according to claim 5 wherein the at least one electronic control module is further operative to provide information related to the hazard object to a parking assist system.

9. The system according to claim 1 wherein the at least one electronic control module is further operable to direct a function change in at least one occupant comfort system based on the occupancy status.

10. The system according to claim 1 wherein the at least one electronic control module comprises a camera control module.

11. The system according to claim 10 wherein the at least one electronic control module further comprises a restraints control module.

12. A dual-mode imaging system for a vehicle having a passenger cabin, the system comprising:
an electro-optical imaging device mountable inside of the passenger cabin for rotating movement between a rear view position wherein the imaging device is oriented to image a back-up area rearward of the vehicle through a window of the vehicle and an seating view position wherein the imaging device is oriented to image a seating area within the passenger cabin;
a drive unit moving the imaging device between the rear view position and the seating view position;
at least one electronic control module selectively operable in an occupant safety mode and in a backup mode based upon a status of at least one vehicle system, the at least one electronic control module operative in the occupant safety mode to direct movement of the imaging device to the seating view position and to determine an occupancy status for at least one seating position in the seating area based upon imagery received from the imaging device, and the at least one electronic control module operative in the backup mode to direct movement of the imaging device to the rear view position;
at least one electronic control module receiving the occupancy status and directing a function change in at least one safety system based on the occupancy status; and a video display screen displaying images from the imaging device when the imaging device is in the rear view position.

13. The system according to claim 12 wherein the at least one safety system comprises a driver alerting system and the function change comprises generating a driver alert.

14. A method of operating an imaging system for a vehicle comprising the following steps:
detecting a status of at least one vehicle system;
based upon the detected status, activating a drive unit to rotate an electro-optical imaging device rotatably mounted inside of a passenger compartment of the vehicle between a rear view position wherein the imaging device is oriented to image an area rearward of the vehicle through a window of the vehicle and an seating view position wherein the imaging device is oriented to image a seating area within the passenger cabin;
when the imaging device is in the rear view position, providing information related to objects imaged by the imaging device to a vehicle operator; when the imaging device is in the seating view position, using the imagery from the imaging device to determine an occupancy status for at least one seating position in the seating area; and
directing a function change in at least one safety system of the vehicle based upon the determined occupancy status.

15. The method according to claim 14 wherein the step of providing information related to objects imaged by the imaging device to the operator comprises displaying imagery from the imaging device on a video display located inside the passenger compartment.

16. The method according to claim 14 further comprising using artificial vision software to analyze imagery from the imaging device in the rear view position and detect an object behind the vehicle, and providing an alert to the operator that the object has been detected.

17. The method according to claim 16 further comprising activating a vehicle braking system in response to detection of the object.

18. The method according to claim 14 wherein the step of directing a function change in at least one safety system comprises changing an operating status of an occupant restraint when there is no occupant present in the at least one seating position.

19. The method according to claim 18 wherein the change in operating status comprises deactivating the occupant restraint.

20. The method according to claim 14 further comprising directing a function change in at least one occupant comfort system based upon the determined occupancy status.
